(19) United States
(12) Patent Application Publication
(10) Pub. No.: US 2016/0098816 A1
(43) Pub. Date: Apr. 7, 2016

(54) WEARABLE-TO-WEARABLE CONTROLS

(71) Applicant: KBA2 INC., San Francisco, CA (US)

(72) Inventors: Jon B. FISHER, San Francisco, CA (US); Steven L. HARRIS, Perris, CA (US); James J. KOVACH, San Rafael, CA (US); Austin A. MARKUS, San Francisco, CA (US); James A. REDFIELD, Boise, ID (US); Richard G. SMITH, Lynnwood, WA (US)

(21) Appl. No.: 14/858,690

(22) Filed: Sep. 18, 2015

Related U.S. Application Data
(60) Provisional application No. 62/058,427, filed on Oct. 1, 2014.

(51) Int. Cl. G06T 3/20; G06T 3/40

(52) U.S. Cl. CPC G06T 3/20; G06T 3/40

(57) ABSTRACT

The present invention provides a number of advantageous modifications and improvements in wearable computing devices to optimize or at least more fully utilize the potential applications of such devices. These modifications include transforming the view of a second observer to be able to view what a first observer at a different location is viewing, allowing the second observer or a remote administrator to control the zoom on the device of a first observer, providing a pointer on the device of the first observer to assist in framing or viewing an object; and controlling the device to avoid overheating or to avoid transmitting redundant or hijacked information.

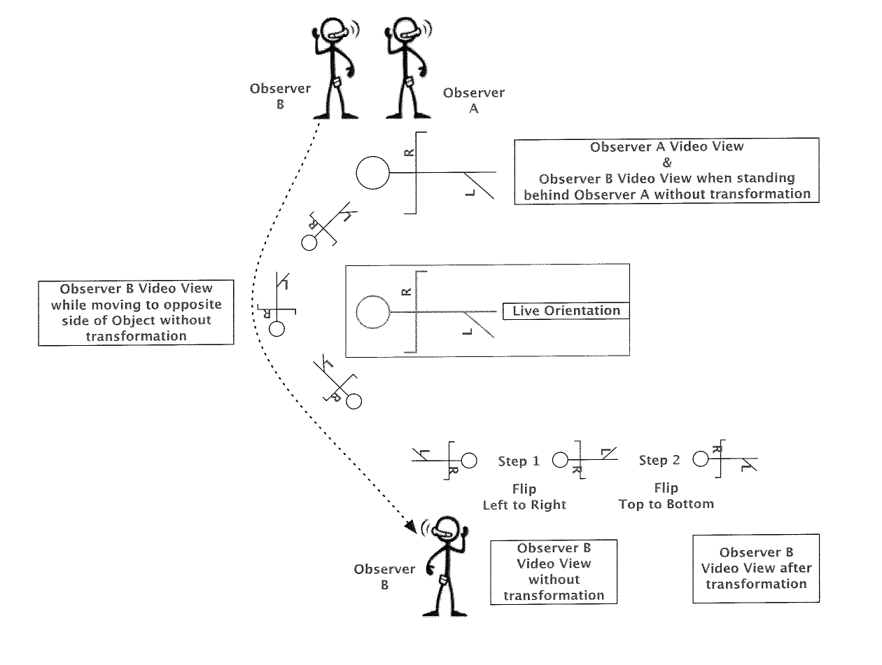

This application claims the benefit of application Ser. No. 62/058,427 filed Oct. 1, 2014, the entire content of which is expressly incorporated herein by reference thereto.

### BACKGROUND OF THE INVENTION

Wearable computing devices are becoming more common and used for a wider variety of activities. On one level, a wearable computing device is a simple video and communications tool. On a deeper level though, these devices are very small computers with audio/video and Wi-Fi capabilities. Few of these wearable devices have robust user interfaces and local control is generally through gestures of some sort. Some of these wearable devices have form factors that blend well into a workflow. And as computing devices, they can communicate with other computers using Wi-Fi or other networking capabilities.

At present, this technology is relatively new and in need of further developments to optimize or at least more fully utilize the potential applications of such devices. The present invention now provides a number of advantageous modifications and improvements for this purpose.

### SUMMARY OF THE INVENTION

The present invention relates to a method of providing a digital image viewed by a first observer to a second observer in a different location, by determining by context factors the relative positions of first and second observers who are viewing an object from different locations; obtaining digital image data from wearable computing devices of the first and second observers; and transforming a digital image obtained by the digital image data of the second observer to be the same as the digital image obtained from the digital image data from the first observer so that the second observer views the object the same way as the first observer. The second image is typically transformed by vertical and horizontal rotation dependent on the spatial location of the two observers.

Another embodiment of the invention relates to an improvement in a method of providing a digital image from a wearable computing device. The improvement comprises providing a pointer on the wearable computing device of an observer to assist in the viewing or framing of the objects being captured by the wearable device.

Another embodiment of the invention relates to an improvement in a method providing a digital image viewed by a first observer to a second observer in a different location. This improvement comprises enabling someone other than the first observer to control the zoom of the wearable computing device of the first observer to assist in the viewing or framing of the object being viewed by the second observer. In one aspect, the second observer controls the zoom of the wearable computing device of the first observer by hand or head gestures or verbal commands. Alternatively, a remote administrator controls the zoom of the wearable computing device of the first user via direct input or an online zoom to assist in the viewing or framing of the object being viewed by the second observer.

The invention also relates to a method to control a wearable device to prevent overheating due to extended use by measuring through algorithmic methods, a heat load of the wearable device as the device is in use; and reducing power to the device when a predetermined heat load is reached to avoid overheating or causing damage to the device. In particular, the wearable device is put into a sleep mode to allow the device to cool when the predetermined heat load is reached.

A further embodiment of the invention relates to a method to conserve energy in a wearable device by analyzing streaming video transmitted by the wearable device; and, when determining that the video or images are stationary for a defined period of time, or when determining that the device is inactive for a specified timeframe, reducing power use of the wearable device or putting the device into a sleep mode to avoid transmitting redundant or non- useful data and/or to conserve energy of the device.

The invention also relates to a method to protect a wearable device from hijacking, by detecting through algorithmic methods, applications that are present or that are being installed on the wearable device; comparing the detected applications to a database of acceptable programs; and when unauthorized applications are detected, shutting down or disabling the wearable device to avoid hijacking of electronic data or images from the wearable device by the unauthorized application.

A further embodiment of the invention is a wearable interface having wireless transmission capability comprising a camera, a view screen and a laser pointer on or associated with the wearable device to assist in obtaining images with the camera for proper framing on the view screen.

### BRIEF DESCRIPTION OF THE DRAWINGS

The sole drawing FIGURE illustrates the positioning of two observers of an object and how the view is transformed so that Observer B has the same view as Observer A.

### DETAILED DESCRIPTION OF THE INVENTION

In general, the present invention provides improvements and modifications relating to the sharing of video from one person to another wirelessly. In the specification that follows, we will refer to each person as an Observer with Observer A being one person who is viewing a particular object or event and is either capturing digital information in the form of a photograph or a video. Observer A would then be transmitting the digital information to Observer B wirelessly who will receive it and wish to view the information sent by Observer A. While the two observers are used for explanation purposes, a skilled artisan would immediately realize that the invention is operative between more than two persons using wearable computing devices where one is inheriting the view of another.

A wearable computing device (or wearable device) is a device that is typically worn by one person that can provide video or pictures to another person without obstructing that person's visual field. A typical example of a wearable device is an electronic device with a frame designed to be worn on the head of the user, i.e., Google Glass, as disclosed for example, in U.S. patent publications U.S. 20130044042 A1 and U.S. 20140022163 A1, the entire content of each of which is expressly incorporated herein by reference thereto. Wearable devices would also include other electronic devices with similar features, in particular, a camera, a view screen and wireless transmission capability, such other devices including but not limited to watches, mobile phones, certain smart cameras and the like.

In one embodiment, Observer B is in a different location than Observer A but is desirous of viewing the digital information in the same was as it is viewed by Observer A, thus maintaining the exact orientation of Observer A's wearable device. For purposes of this description we will discuss Observer A streaming video or taking still pictures of an object through a wearable device (e.g. Google Glass) and Observer B receiving the video or still picture through their wearable device. If Observer B is directly behind Observer A the view Observer B sees is identical to that of Observer A. If Observer B moves to the opposite side of the object, the view seen by Observer B will be upside down and backwards. To continue to see the view of Observer A, the view provided to Observer B's wearable device will have to be transformed.

The drawing FIGURE illustrates Observers A and B looking at a particular subject. The object orientation box is an actual representation of what Observers A and B are viewing. The Observer A view and Observer B view without transformation is shown between the object orientation and the position of the Observers. If, as shown, Observer B moves to the opposite side of the object, his view would be inverted from Observer A would see. To compensate for the difference in view, the software in the device would first flip the image from left to right (rotated 180 degrees along the vertical axis) and then flip it from top to bottom (rotated 180 degrees along the horizontal axis) to transform the viewed image to one having the same orientation as the view that Observer A would have.

In the situation where Observer B is not opposite to Observer A but is at some other position, e.g., 90 degrees away from Observer A along a circle that surrounds the object to be viewed, the software can calculate the appropriate vertical rotation to initially position the view so that after the horizontal rotation the view of Observer A is obtained. The same type of calculation can be made to the horizontal rotation if Observer B is at a higher or lower location from the object than Observer A. The measurement of context vectors to determine the location of an object that is being viewed by multiple viewers is known from U.S. patent publications U.S. 20120059826 A1 and U.S. 20110117934 A1, the entire content of each of which is expressly incorporated herein by reference thereto. These vectors can be used to determine the relevant positions of Observers A and B so that the appropriate transformation data can be generated.

A particular application of this embodiment would be to assist a doctor in viewing a surgery carried out by a resident. Observer A, e.g., the attending physician, can inherit the view of Observer B, e.g., the resident, when the physician is on the opposite side of the patient from the resident by transforming the view with the rotation and flip noted above in order for the view of the attending physician as a teacher to be identical to that of the resident as student. This rotation and inversion allows the physician to directly instruct the resident as to the correct positioning of surgical instruments and had or surgical movements. Many other cases can be detailed in manufacturing, maintenance, and diagnostics.

Another embodiment of the invention relates to the use of gestures by Observer B to control zooming in or out of the view Observer B inherits from Observer A's wearable device. One way to do this is to allow Observer B to zoom in or out on Observer A's view via a gesture by Observer B. This enables Observer B to control video zooming with a simple, non-tactile gesture. One such gesture can be the movement of Observer B's head. For example a nod could indicate zooming in while a side to side head movement could indicate zooming out. Instead of a head gesture, a hand gesture could be used with motion in one direction indicating enlargement and motion in a different or the opposite direction indicating a decrease in the size of the image. Alternatively, a voice command from Observer B could be used to cause the camera of Observer A's wearable device to zoom in for a closer view of the object. Thus, Observer B's actions control Observer A's device so that Observer B can obtain a closer (or more distant) view of the inherited view from Observer A. The instructions for zooming that are carried back to Observer A's device is routed through an app that is on both Observer A's and B's device.

This feature allows Observer B to gain a better view without having to request that Observer A change the view so that Observer B does not disrupt or distract Observer A from whatever actions he is taking In the surgery example given above, the physician could obtain a better view of the resident's actions without having to interrupt or disturb the surgery that is being carried out by the resident.

Technology for converting gestures into signals for controlling zoom are known from U.S. patent publication U.S. 20140208274 A1, the entire content of which is expressly incorporated herein by reference thereto, but that publication does not disclose the features of how to use such information to improve received video quality as disclosed herein.

The invention also relates to the control of a wearable device by a remote dashboard administrator who could control the zoom function via direct input or an online zoom function. In this situation, Observer B would be a remote administrator that views the video to be transmitted to others and adjust the view by zooming in or zooming out to enhance the quality of the video. For example, the administrator could assure that the object is properly appearing in the video frame, is more or less centered or is at least full and not cut off or out of view. As in the prior embodiment, the zooming can be adjusted without disturbing, distracting or interrupting Observer A who is taking the video.

A further improvement to the video that is obtained by Observer A is the incorporation of a laser pointer on or associated with the wearable device to assist the Observer in obtaining video by indicating the center of the video stream when the Observer, an administrator, or other broadcaster beams video streams wirelessly to remote audiences. The laser pointer can be integral with the device or it can be provided as a detachable component that can be added to the device when desired for optimum video gathering. In connection with the zooming embodiments, the laser pointer can be helpful in properly centering or framing the video for the necessary enlargement or shrinkage of the view, as the pointer acts as a reference to keep the correct area of the object in the center of the view.

Yet another embodiment relates to the control of the wearable device to prevent overheating due to extended use. Through algorithmic methods, the heat load of the wearable device is measured as the device is in use. When a predetermined heat load is reached, one that can cause damage to the device or degradation of the stream, the wearable device is put into a sleep mode wherein the power usage is diminished to allow the device to begin to cool. Alternatively, as the device begins to heat up, the camera power usage can be reduced to prevent heat buildup in the wearable device. While there may be some compromise on the quality of the video, the alternative would allow the video to continue while indicating to the Observers that the device is beginning to build up heat. Both alternatives avoid damage to the device as well as safety for the user to prevent burns or discomfort caused by the overheating of the device.

Another embodiment for the control of operation of the wearable device is the analysis of the streaming video or other energy consuming activities. When the video or images are stationary for a defined period of time, or when the device is inactive for a specified timeframe, the power use of the wearable device is reduced or the device is put into a sleep mode to avoid transmitting redundant or non-useful data and/or to conserve energy of the device. Both video streaming and device inactivity are determined algorithmically.

A related embodiment for control of the operation of the wearable device is the provision of an automatic shutoff or shutdown of the video device when an unauthorized app is detected or is attempted to be installed on the device. Through algorithmic methods, the applications that are present or that are being installed on the wearable device are detected and compared to a database of white-listed, acceptable programs that the user of the device is allowed to load onto the device. When unauthorized applications are detected, the wearable device is shut down and not allowed to start up, thus avoiding hijacking of electronic data or images from the wearable device by the unauthorized application.

With respect to the gear-to-gear view-transformation technology, the system can receive input signals such as packets, messages, or digital signals that communicate the coordinates, compass heading, or other physical location information for each observer (i.e., the gear worn by the observer) such as from the on-board sensors of the gear. The system can be configured to allow direct wireless communication and coordination between two or more user-worn gear devices. Alternatively or in combination, a server can be configured to be in communications (two-way signals) between the server and the gear to receive and coordinate the data (e.g., compass heading) and images (e.g., for distribution). The system can be configured to transmit a stream of video or still images to the gear or between gear. A server or other device can be an intermediary (e.g., to act as the distribution point) or the gear can stream video or images directly to each other. If desired, the gear can implement security to prevent access to the stream, devices, or the network. The gear can also be configured to implement a private network using their onboard network communications features to establish a network comprising the two gear devices involved in the process.

In preferred embodiments, the system performs the transformation and distribution of video or images in real time such that the viewers are viewing the same object at the same time (or without noticeable delay). This can allow “live” collaboration and operation on a project or object.

Also, to perform the transformation, the server or the gear can receive compass heading or other location or heading information and operate on this information from the first gear and the second to determine the spatial relationship between the direction or object that each observer is facing. With this operation, the transformation can be dynamically applied to an image or a stream to adjust to the relational difference in position and perspective between the two gears.

Software that implements the embodiments described herein can be saved on transient and non-transient computer memory for execution or later retrieval.

It is generally understood that wearable gear, computers, or servers will typically include a processor such as a CPU, RAM, ROM, communications network components, storage (such as a hard drive, or non-volatile memory), and peripherals (or components for communicating with peripherals). The processor is configured to perform logical and arithmetical operations on the data as specified in the software.

1. A method of providing a digital image viewed by a first observer to a second observer in a different location, which comprises:
determining by context factors the relative positions of first and second observers who are viewing an object from different locations;
obtaining digital image data from wearable computing devices of the first and second observers; and
transforming a digital image obtained by the digital image data of the second observer to be the same as the digital image obtained from the digital image data from the first observer so that the second observer views the object the same way as the first observer.

2. The method of claim 1 wherein the second image is transformed by vertical and horizontal rotation dependent on the spatial location of the two observers.

3. The method of claim 1 which further comprises providing a pointer on the wearable computing device of at least the first observer to assist in the viewing or framing of the object being viewed by the second observer.

4. The method of claim 1 which further comprises enabling the second observer to control the zoom of the wearable computing device of the first observer to assist in the viewing or framing of the object being viewed by the second observer.

5. The method of claim 4, wherein the second observer is able to control the zoom of the wearable computing device of the first observer by hand or head gestures or verbal commands.

6. The method of claim 1 which further comprises enabling a remote administrator to control the zoom of the wearable computing device of the first user via direct input or an online zoom to assist in the viewing or framing of the object being viewed by the second observer.

7. The method of claim 1 which further comprises:
measuring through algorithmic methods, a heat load of the wearable device of the first observer as the device is in use; and
reducing power to the device when a predetermined heat load is reached to avoid overheating or causing damage to the device.

8. The method of claim 1 which further comprises:
analyzing streaming video transmitted by the wearable device of the first observer; and
when determining that the video or images are stationary for a defined period of time, or when determining that the device is inactive for a specified timeframe, reducing power use of the wearable device or putting the device into a sleep mode to avoid transmitting redundant or non-useful data and/or to conserve energy of the device.

9. The method of claim 1 which further comprises:
detecting through algorithmic methods, applications that are present or that are being installed on the wearable device of the first observer;
comparing the detected applications to a database of acceptable programs; and
when unauthorized applications are detected, shutting down or disabling the wearable device to avoid hijacking of electronic data or images from the wearable device by the unauthorized application.

10. (canceled)

11. In a method of providing a digital image viewed by a first observer to a second observer in a different location, the improvement which comprises enabling someone other than the first observer to control the zoom of the wearable computing device of the first observer to assist in the viewing or framing of the object being viewed by the second observer.

12. The method of claim 11, wherein the second observer controls the zoom of the wearable computing device of the first observer by hand or head gestures or verbal commands.

13. The method of claim 11, wherein a remote administrator controls the zoom of the wearable computing device of the first user via direct input or an online zoom to assist in the viewing or framing of the object being viewed by the second observer.

14.-17. (canceled)

18. A wearable interface having wireless transmission capability comprising a camera, a view screen and a laser pointer on or associated with the wearable device to assist in obtaining images with the camera for proper framing on the view screen.

19. The method of claim 11, wherein the improvement further comprises providing a pointer on the wearable computing device of an observer to assist in the viewing or framing of the objects being captured by the wearable device.

20. The wearable device of claim 18 which includes a processor for preventing overheating of the device due to extended use, wherein the processor is configured for measuring through algorithmic methods, a heat load of the wearable device as the device is in use; and reducing power to the device when a predetermined heat load is reached to avoid overheating or causing damage to the device.

21. The wearable device of claim 20, wherein the processor places the wearable device into a sleep mode to allow the device to cool when the predetermined heat load is reached.

22. The wearable device of claim 18 which includes a processor for conserving energy in the device, wherein the processor is configured for analyzing streaming video transmitted by the wearable device; and when determining that the video or images are stationary for a defined period of time, or when determining that the device is inactive for a specified timeframe, reducing power use of the wearable device or putting the device into a sleep mode to avoid transmitting redundant or non-useful data and/or to conserve energy of the device.

23. The wearable device of claim 18 which includes a processor for protects the device from hijacking, wherein the processor is configured for detecting through algorithmic methods, applications that are present or that are being installed on the wearable device;
comparing the detected applications to a database of acceptable programs; and when unauthorized applications are detected, shutting down or disabling the wearable device to avoid hijacking of electronic data or images from the wearable device by the unauthorized application.
